(19) United States
(12) Patent Application Publication
(10) Pub. No.: US 2022/0281480 A1
(43) Pub. Date: Sep. 8, 2022

(54) VEHICLE CHARACTERISTICS, MOTION STATE, PLANNED MOVEMENTS AND RELATED SENSORY DATA SHARING AND NETWORKING FOR SAFE OPERATION OF GROUPS OF SELF-DRIVING AND DRIVING ASSISTED VEHICLES

(71) Applicant: Omnitek Partners LLC, Ronkonkoma, NY (US)

(72) Inventor: Jahangir S Rastegar, Stony Brook, NY (US)

(73) Assignee: Omnitek Partners LLC, Ronkonkoma, NY (US)

(21) Appl. No.: 17/686,334

(22) Filed: Mar. 3, 2022

Related U.S. Application Data
(60) Provisional application No. 63/156,254, filed on Mar. 3, 2021.

(51) Int. Cl. B60W 60/00; B60W 30/095

(52) U.S. Cl. CPC B60W 60/0017; B60W 30/0953; B60W 30/0956; B60W 2554/4049

(57) ABSTRACT

A method for controlling a group of self-driving vehicles in a predetermined geographical area including: separating the predetermined geographical area into at least first and second sub-sections, wherein the predetermined geographical area has a corresponding area controller and each of the at least first and second sub-sections has a corresponding sub-section controller; separately controlling a sub-group of the self-driving vehicles within each of the at least first and second sub-sections using the corresponding sub-section controller; and the area controller informing each corresponding sub-section controller of a change in a self-driving vehicle in the at least first or second sub-sections.

### CROSS-REFERENCE TO RELATED APPLICATIONS

This application claims the benefit of U.S. Provisional Application No. 63/156,254, filed on Mar. 3, 2021, the entire contents of which is incorporated herein by reference.

### BACKGROUND

### 1. Field

The present disclosure relates generally to methods and means of determining and sharing current motion state and planned movements of a vehicle with other vehicles, particularly those in relatively close proximity, through networking to achieve safe operation of self-driving and driving-assisted vehicles so as to minimize chances of accidents and their severity when they may occur.

### 2. Prior Art

Visions of driverless cars moving around on highways of the future are nothing new. Visions of automated highways date back to at least the 1939 New York World's Fair. Also, the push-button driverless car was a common dream depicted in such midcentury utopian artifacts as 1958's Disneyland TV episode “Magic Highway, U.S.A.”

Today, self-driving vehicles are being developed for many reasons. One main indicated reason is to save tens of thousands of lives per year since the majority of vehicle-related deaths are caused by driver error. Tests have shown that self-driving vehicles nearly eliminate self-inflicted accidents, although they are not immune to accidents caused by human drivers of other vehicles. Self-driving vehicles have unlimited attention spans and can process complex sensor data nearly instantaneously. Studies have shown the potential of self-driving vehicles to save lives at a very impressive rate, thereby their development is considered to be imperative for at least this reason.

The National Highway Traffic Safety Administration (NHTSA) reported that rear-impact collisions result in more injuries and property damage than any other type of automobile accident. Over 2.5 million rear-impact collisions occurred in 1999, causing 2,149 deaths. The NHTSA stated in 2001 that an extra second of warning time could prevent 90% of all rear-impact collisions; averting 2.25 million rear-end crashes a year. Center High Mounted Stop Lights (Third Brake Light) have displayed long-term effectiveness in reducing rear impact crashes by 4.3 percent in passenger cars and lightweight trucks. Even a 4 percent reduction in rear-end collisions may represent some 25,000 injuries prevented each year. Statistics show that just adding Center High Mounted Stop Lights (Third Brake Light: since 1986) prevents 92,000 to 137,000 police-reported crashes, 58,000 to 70,000 nonfatal injuries, and $655 million in property damage a year.

Rear-impact collisions account for more than 20% of all motor vehicle crashes. In 1993, for example, it is estimated that there were more than 1.5 million rear-impact crashes, and over 600,000 injured occupants. Michael Flannagan, a research professor at the University of Michigan's Transportation Research Institute stated that there are a finite number of signals drivers can be expected to respond to, but any modification that can add even a fraction of a second to a driver's reaction time and potentially reduce the 40,000 fatalities on U.S. roads from automobile accidents each year, which cost the economy some $230 billion a year, or about $820 per person according to the NHTSA, is important.

As currently known, a self-driving, also known as autonomous vehicles (AV), connected and autonomous vehicles (CAV), driverless cars, robo-cars, robotic cars, autonomous mobile platforms, or other similar names, is a vehicle that is capable of sensing its environment and moving safely with little or no human input.

In general, “autonomy” in a vehicle is defined as the vehicle making driving decisions without intervention of a human. As such, a certain level of autonomy already exists in most cars, such as in the form of “cruise control” and “Antilock Brake Systems” (ABS) and in some car models devices such as advanced cruise control, lane keeping support, lane change warning, and obstacle avoidance systems, all of which expand the range of autonomous behavior. Other related features include warning devices, such as collision warning, backup parking and parallel parking aids, which can be totally autonomous with the addition of means of actuation. In addition, truck convoys and driverless busses in enclosed areas have also seen limited operational deployment.

Current self-driving cars combine a variety of sensors to perceive their surroundings, such as camera, radar, lidar, sonar, GPS, odometry, inertial measurement units, and others. Onboard computer software and control systems interpret the sensory information to identify appropriate navigation paths, static and dynamic obstacles, and road signs.

Self-driving vehicles could also save time and improve convenience in roadway travel. Specifically, self-driving vehicles have the potential to learn from their environment and users to improve their performance. The self-driving vehicles may also help reduce congestion by properly following traffic and safe driving rules. They can also reduce the chances of accidents with other vehicles by trying to make proper maneuvers.

The provided sensory instruments on self-driving vehicles would reduce accidents since the self-driving vehicle computer(s) can monitor many more events than is humanly possible for a human driver. This is already shown to be the case with driver assisted cars in which sensory information monitoring the vehicle speed and distance between vehicles, etc., assists drivers to monitor even the blind spot around the vehicle. There are also those that have pointed out that a driver may rely too much on these vehicle provided inputs and begin to pay less attention to other sources of hazard, which would have otherwise had paid attention to.

The provided sensory instruments on self-driving vehicles could also reduce accidents in cases when certain sudden vehicular components or systems fail, such as if a tire blows up, or when certain undetectable environmental hazardous conditions are encountered, such as when a relatively large water filled pot hole or an object that the vehicle sensors cannot detect in time is encountered. In all such cases, the self-driving vehicle control computer can be programmed to initiate the proper response to avoid accidents with other vehicles, either react and make corrective actions or bring the vehicle safely to a stop.

Self-driving vehicles could also reduce transportation costs by reducing the amount of fuel or electrical energy used by the vehicle by optimal planning and executing driving. They can also reduce occupant's stress and road-rage and related incidents.

In summary, the benefits of self-driving vehicles, once fully developed, has been well documented in the various studies since early in the twentieth century.

The above benefits of the self-driving vehicles and driver-assisted vehicles can significantly be improved, and significantly other benefits may also be achieved with the novel methods and apparatus of the present invention as described in this disclosure.

In current self-driving vehicles, the sensory and other information that is collected is essentially used by the vehicle control system alone. If all “nearby” vehicles can share these and other relevant collected, available, and stored information, then the collection of self-driving vehicles can achieve a tremendously higher performance in all aforementioned aspects, while providing the means of achieving a significant number of other advantages and functionalities that are not possible while the sensory and other related information is essentially only available to individual self-driving vehicles.

Self-driving or Autonomous Vehicle (AV) technology can provide a safe and convenient transportation solution for the public, but the complex and various environments in the real world make it difficult to operate safely and reliably. A Connected Autonomous Vehicle (CAV) is an AV with vehicle connectivity capability, which enhances the situational awareness of the AV and enables the cooperation between AVs. Hence, CAV technology can enhance the capabilities and robustness of AV.

Compared to AV, CAV is equipped with Dedicated Short Range Communications (DSRC) or cellular networks, which enables it to exchange information or cooperate with other road users. From an information exchange perspective, CAV capabilities can be used for many purposes such as safety-related information exchanges.

For cooperation with other road users, CAV has been proposed to be divided into two categories: (a) information-based cooperation, and (b) maneuver-based cooperation (C. Burger et al., “Rating cooperative driving: A scheme for behavior assessment,” in Proc. IEEE 20th Int. Conf. Intell. Transp. Syst. (ITSC), October 2017, pp. 1-6.). In the information-based cooperation, agents share their own information, like system states, sensor information, and intention, with each other, and they utilize the received information to optimize their own utility. In maneuver-based cooperation, agents not only share their own information with each other but also incorporate other agents' utility in their own planning layer to optimize the total utility of all agents.

Proposed technologies such as Cooperative Adaptive Cruise Control (CACC), Cooperative Perception and Cooperative Prediction, belong to the information-based cooperation. In CACC, vehicles would share their states, like desired acceleration, actual acceleration or actual velocity, to shorten the vehicle-following gap and improve vehicle safety, fuel economy and traffic throughput [(R. Kianfar et al., “Design and experimental validation of a cooperative driving system in the grand cooperative driving challenge,” IEEE Trans. Intell. Transp. Syst., vol. 13, no. 3, pp. 994-1007, September 2012), (S. Li, K. Li, R. Rajamani, and J. Wang, “Model predictive multi-objective vehicular adaptive cruise control,” IEEE Trans. Control Syst. Technol., vol. 19, no. 3, pp. 556-566, May 2011), and (Y. Lin and A. Eskandarian, “Experimental evaluation of cooperative adaptive cruise control with autonomous mobile robots,” in Proc. IEEE Conf. Control Technol. Appl. (CCTA), August 2017, pp. 281-286.)]. In cooperative perception, vehicles share detected obstacles or perception data to extend their perception horizon, which improves their situational awareness and safety. In cooperative prediction, vehicles receive the intention or desired trajectory from others to predict their motion more efficiently and improve ego-planning utility.

Cooperative Adaptive Cruise Control (CACC), cooperative perception and cooperative intersection control are also some of the popular cooperative techniques that have been studied in recent years. The most popular CACC structure is the predecessor-following topology (e.g., Z. Wang, G. Wu, and M. J. Barth, “A review on cooperative adaptive cruise control (CACC) systems: Architectures, controls, and applications,” in Proc. 21st Int. Conf. Intell. Transp. Syst. (ITSC), November 2018, pp. 2884-2891). In this structure, the ego-vehicle receives the inter-vehicle distance to the predecessor and the desired acceleration of the predecessor through radar and wireless communication, respectively. The CACC controller utilizes this information to control the vehicle longitudinal speed and keep a constant distant/headway to its predecessor.

The vehicle trajectory tracking strategies of different types have been studied to provide sufficient steering angle, throttle, and braking input to control the vehicle, which ensures the vehicle's longitudinal and lateral motions following the desired trajectory, including the following control strategies to perform trajectory tracking, path tracking or speed tracking.

The geometric-vehicle-model-based controllers have been proposed, which are easy to implement, but they are not capable to achieve a good tracking performance at high speed, due to ignoring vehicle velocity and acceleration. Some advanced algorithms are combined to accommodate vehicle dynamics, which improves its performance at high speed.

Another method considered uses a PID controller, which is a simple and effective classical approach, which can be found in the literature for both vehicle's lateral and longitudinal control. However, even a well-designed PID controller still has low robustness.

Various linear and non-linear feedback and feedforward control approaches have also been proposed for trajectory tracking control. The vehicle dynamics and the trajectory parameters can be considered in the design of feedback control law. For example, a conventional feedback approach, utilizing lateral offset and heading deviation as well as their derivatives as the states, has been studied to achieve lateral control (e.g., R. Rajamani, Vehicle Dynamics and Control. New York, N.Y., USA: Springer, 2011). Other stability based feedback control approaches have also been proposed to avoid unintended lane departure and collisions (e.g., A. Benine-Neto, S. Scalzi, S. Mammar, and M. Netto, “Dynamic controller for lane keeping and obstacle avoidance assistance system,” in Proc. 13th Int. IEEE Conf. Intell. Transp. Syst., September 2010, pp. 1363-1368). The feedback control can compensate the disturbances slowly, such as lateral wind and curvature varying, whereas the feedforward control is suitable for handling rapid variation (e.g., H. Qu, E. I. Sarda, I. R. Bertaska, and K. D. von Ellenrieder, “Wind feed-forward control of a USV,” in Proc. OCEANS Genova, May 2015, pp. 1-10, and W. Wang, J. Xi, C. Liu, and X. Li, “Human-centered feed-forward control of a vehicle steering system based on a driver's path-following characteristics,” IEEE Trans. Intell. Transp. Syst., vol. 18, no. 6, pp. 1440-1453, June 2016). The feedback and feedforward are frequently combined together to achieve controller robustness.

Currently proposed and studied trajectory tracking methods still face several challenges. The first challenge in trajectory tracking is the balance between model fidelity and computational efficiency. In most current studies, the vehicle models are simplified as a linear model, and many effects have been ignored, which might lead to a big model mismatch in certain circumstances. But currently proposed high-fidelity models will lead to a high computational cost, which makes it difficult in real-time applications. The second challenge is in high-speed circumstances, especially at the limits of handling. When the vehicle travels at the physical limits of tire friction, which also generates the yaw rate oscillation. And a less conservative vehicle stability envelope at the handling limits should be derived since most of the stability constraints are derived through the steady-state models. The third challenge is the development of controllers that are highly fault-tolerant and have high robustness. Although some system faults, such as delay and data dropout, have been studied in many research, the time-varying and unknown faults remain unsolved. The current robust controllers are designed against one or several kinds of known bounded disturbances or uncertainties separately, but combined disturbances or taking disturbances and uncertainties into account together has not yet been solved. Finally, lowering the computational cost of robust intelligent controllers is also a challenge.

Currently, linear consensus control, Model Predictive Control (MPC), and optimal control are three main types of control strategies that are being investigated for CACC. Linear consensus control is a distributed control method, which mostly uses the desired acceleration as the feedforward signal and the inter-vehicle distance error as the feedback signal to calculate the total control action. The linear consensus control method can provide for string stability of CACC platoon, but it cannot describe the nonlinear dynamics and constraints. However, the MPC controller can handle nonlinear dynamics and constraints, and it is also able to predict the future response of the system. The optimal control, like dynamic programming, can formulate CACC as a convex optimization problem to minimize energy consumption, which also can deal with nonlinearity and constraints.

There are still many challenges in currently investigated CACC, such as a reliable control method that can handle changing wireless communication topologies, varying communication delays, packet loss should be studied, etc.

Another area related to CAV technologies that are under investigation is cooperative perception. The cooperative perception shares the individual perception information among vehicles, which extends the line of sight and field of view of each CAV. Each CAV can improve its safety over a short range and increase the traffic flow efficiency over a long range.

The cooperative perception can be regarded as solving a map merging problem, which unifies the perception information among vehicles and maps it into a global coordinate frame. Hence, the relative pose estimation between vehicles needs to be finished first and then the perception information from each vehicle can be merged by scan matching and some image mapping techniques. The relative pose estimation is usually done by triangulation and the priori localization methods. The image data from vision sensors are physical quantities recorded by the spatial coordinate in the vision system. Hence, the image data from the vision sensor should be merged by some other techniques.

To make cooperative perception more reliable for CAV, some challenges still need to be addressed. The first challenge is the perception error propagation, in which a vehicle shares its false perception data and other vehicles might make the wrong decision based on this data. One possible solution is each vehicle uses an efficient method to validate the same information from multiple sources. The second challenge is that communication latency and bandwidth might reduce the efficiency of cooperative perception. The third challenge is an efficient data association method for different vehicle and sensor architecture is needed. The fourth challenge is the performance of cooperative perception heavily relies on the relative localization accuracy. But the relative localization accuracy might be low in some situations. Hence, a robust relative localization method needs to be developed for cooperative perception.

Although substantial progress has been made on CAV research, there are many basic issues that prohibits implementation of currently envisioned and studied CAV. With currently pursed strategies, the complex computational and technical challenges of multi-vehicle cooperative perceptions and connected and coordinated motions have too many safety, robustness, and reliability issues to resolve before making it practical for implementation.

### SUMMARY

Accordingly, a method for controlling a group of self-driving vehicles in a predetermined geographical area is provided. The method comprising: separating the predetermined geographical area into at least first and second sub-sections, wherein the predetermined geographical area has a corresponding area controller and each of the at least first and second sub-sections has a corresponding sub-section controller; separately controlling a sub-group of the self-driving vehicles within each of the at least first and second sub-sections using the corresponding sub-section controller; and the area controller informing each corresponding sub-section controller of a change in a self-driving vehicle in the at least first or second sub-sections.

The can further comprise transmitting vehicle information from each self-driving vehicle in each of the at least first and second sub-sections to each corresponding sub-section controller. The method can further comprise, prior to the transmitting, storing the vehicle information in each self-driving vehicle in each of the at least first and second sub-sections.

The informing can comprise informing the first sub-section when an other self-driving vehicle, that is not part of the sub-group of the self-driving vehicles corresponding to the first sub-section, enters the first sub-section. The method can further comprise controlling the other self-driving vehicle along with the corresponding group of self-driving vehicles in the first sub-section.

The method can further comprise, the corresponding sub-section controller receiving sensory information from one or more of the self-driving vehicles in the corresponding sub-group of self-driving vehicles in the first sub-section and controlling the corresponding sub-group of self-driving vehicles in the first sub-section based on the received information.

The method can further comprise, each of the self-driving vehicles of the first sub-group of self-driving vehicles in the first sub-section receiving sensory information from one or more of the self-driving vehicles in the corresponding sub-group of self-driving vehicles in the first sub-section and controlling the sub-group of self-driving vehicles in the first sub-section based on the received information.

The method can further comprise, the corresponding sub-section controller receiving broadcast information and controlling the corresponding sub-group of self-driving vehicles in the first sub-section based on the received information.

Wherein in a sub-section controller malfunction, a vehicle controller on-board one or more of the corresponding sub-group of self-driving vehicles can act as the sub-section controller.

Also provided are control systems for performing the methods disclosed herein, and storage devices for storing program instructions for carrying out such methods.

### BRIEF DESCRIPTION OF THE DRAWINGS

These and other features, aspects, and advantages of the apparatus of the present invention will become better understood with regard to the following description, appended claims, and accompanying drawings where:

FIG. 1 illustrates a schematic view of a self-driving vehicle.

FIG. 2 illustrates a geographical section divided into sub-sections and sub-sub-sections and having a corresponding section controller.

FIG. 3 illustrates a sub-section of FIG. 2 having a corresponding sub-section controller.

FIG. 4 illustrates a sub-sub-section of FIG. 2 having a corresponding sub-sub-section controller.

### DETAILED DESCRIPTION

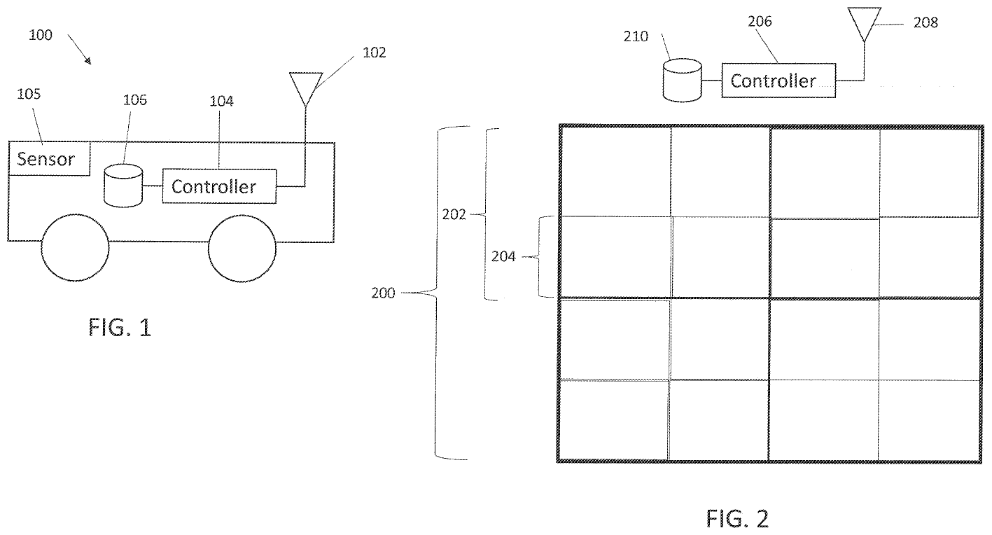

Referring to FIGS. 1-4, self-driving control methods and systems are illustrated to share collected sensory, stored, and other relevant information between self-driving vehicles so that the self-driving vehicles can operate as a “single” “organism”, which can also learn from its interactions and make some of the decisions based on acquired “artificial intelligence”. The methods and systems is hereinafter referred to as an “Intelligent Collective Self-Driving Vehicle System” or (ICSDVS).

It is appreciated that since large scale implementation of such novel technologies and methods and means of sharing their collected and stored data as well as information that may be provided by other sources such as locally broadcasted information is not expected to be possible, therefore it is highly desirable that these novel methods be implementable in steps, so that the “collectively operating and decision making” “organism” may be allowed to grow in capabilities and “smartness” and “intelligence” over time.

It is therefore necessary for the “Intelligent Collective Self-Driving Vehicle System” to provide a network and each self-driving vehicle 100 with transmitter and/or receiver 102 for receiving and/or transmitting and/or broadcasting their planned movements, motion status, and any other collected sensory information about the nearby environment, etc., so that the information would be available to be shared with all other “nearby” vehicles 100 so that the ICSDVS could properly plan and execute a safe and optimal driving of all self-driving vehicles to their destinations. The self-driving vehicle 100 also includes its own controller 104 and storage device 106 operatively connected thereto. Such controller 104 can be integral with the vehicle controller for controller the operation of the vehicle or spate therefrom. Similarly, the storage device 106 can be separately provided from that of the vehicle having instructions for operating the vehicle or integrally therewith. Such control is referred to in the art as a hierarchical control (“HIERARCHY OF CONTROLS”).

It is appreciated that the terms “transmitting” and “broadcasting” herein (whether between self-driving vehicles or section controllers or between section controllers and vehicles) are meant to include all possible means such as optical, RF, acoustic, etc., and their combinations that may be used to transmit the information directly or indirectly to the IC SDVS network.

It is also appreciated that the information from the ICSDVS network may also be made available to self-driving, driver-assisted, or any other vehicle that is not part of the network, i.e., can only receive at least part of the ICSDVS network available information and/or is only capable of “transmitting” and/or “broadcasting” some of the aforementioned planned movements and sensory and other relevant information. This capability of the “Intelligent Collective Self-Driving Vehicle System” would not only provide the means for increasing safety to all the vehicles involved, but it would also provide the capability to partially or fully integrate other vehicles into the ICSDVS network.

Each self-driving vehicle of the ICSDVS network can also be configured to sense driving conditions and transmit and/or broadcast the same (e.g., any dangerous conditions, such as potholes, debris, icy and slippery conditions, disabled vehicle location etc) to any part of the ICSDVS network.

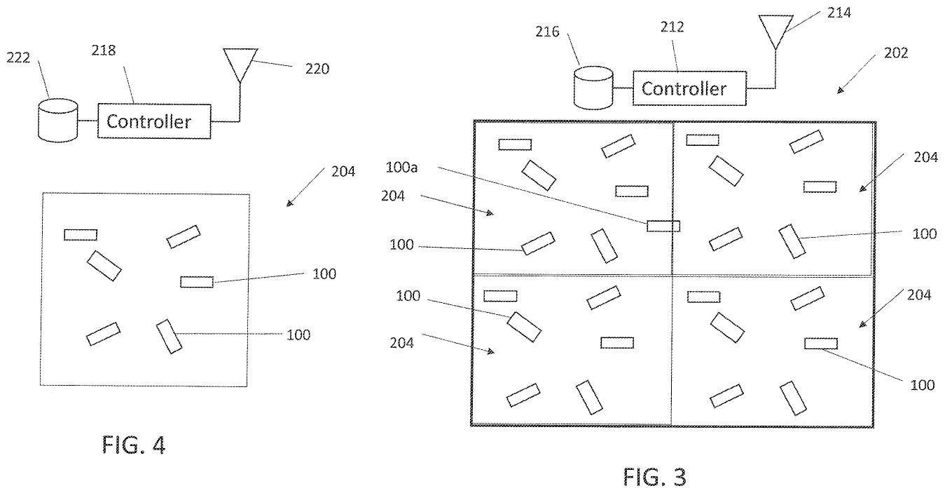

Referring now to FIG. 2, a simple representation of a global ICSDVS network 200 is schematically illustrated. Such global network 200 (or section) has four sub-sections 202, each of the sub-sections 202 having four sub-sub-sections 204 having corresponding self-driving vehicles 100 located within its boundaries. As shown in FIG. 2, the global network (section) has a corresponding global controller 206 with a transmitter and/or receiver 208 and corresponding storage device 210. Referring to FIG. 3, one of the sub-sections 202 from FIG. 2 is schematically illustrated as having four sub-sub-sections 204. The sub-section 202 also has a corresponding sub-section controller 212 with a transmitter and/or receiver 214 and corresponding storage device 216. In FIG. 3, a self-driving vehicle 100a is illustrated as crossing a boundary between sub-sub-sections 204. Referring to FIG. 4, one of the sub-sub-sections 204 from FIG. 2 is schematically illustrated as having a corresponding sub-sub-section controller 218 with a transmitter and/or receiver 220 and corresponding storage device 222.

The ICSDVS, through any of its receivers, can also be configured to receive information about traffic and road conditions, planned and ongoing road construction and repairing and other works from the traffic, highway, weather forecasting and other related authorities.

The sensors 105 (FIG. 1) for detecting various hazardous conditions can be provided to ICSDVS networked self-driving vehicles 100. The hazardous conditions may include existence and severity of bumps; potholes; water pools; surface icing; high gusts; certain large enough objects; down trees, down power lines; and other similar hazardous conditions that the ICSDVS needs to consider while planning movements or attempting to modify the previous plans. Such information can then be broadcast directly between the other self-driving vehicles 100 or to the corresponding section controller and then to the self-driving vehicles.

Since the IC SDVS can cover very wide areas, eventually the entire country and possibly more than one country, for both reliability and efficiency as well as cost effectiveness, a the ICSDVS can be configured to form “sub-networks” and smaller “local networks” and “distributed” networks to address more regional and local movement demands.

To achieve an exceptionally reliable ICSDVS, the system can be provided with redundancies. For this purpose, each networked self-driving vehicle 100 can be configured to serve as a node and make safe local decisions even alone and as a local network with nearby self-driving vehicles in case that a larger regional networks, sub-networks, or the ICSDVS network has failed or is slow in response for some reason.

The methods and systems provide onboard determination of the motion status of a self-driving vehicle and determining and sensing road hazards and transmits and/or broadcasts the information to the ICSDVS and also makes the information available to other self-driving vehicles through the established regional networks, sub-networks, local networks, etc.

The methods and systems can also receive the transmitted information by nearby vehicles and/or their drivers for the purpose of taking appropriate actions to avoid collision or other dangerous conditions and events, such as loss of control, running into stationary or moving vehicles or people or animals, or being diverted into incoming traffic, or any other similar hazardous conditions that could lead to damage to property and/or injury.

The methods and systems can process the received broadcasted information onboard the nearby vehicles so that a possible process (maneuver) can be identified that would avoid an accident and/or damage and/or injury to all involved. It is appreciated that once such a maneuver is formulated, the vehicle involved can broadcast the related information so that other dangerous conditions do not result with the execution of the planned maneuver. It is also appreciated by those skilled in the art that when several nearby vehicles are involved, the plan of action be developed collectively. The implementation of such a collective planning of the response to a dangerous condition is particularly made possible with the processing power that is provided in driverless vehicles.

In maneuver-based cooperation, vehicles receive the sensor data, intention or desired trajectory from other vehicles and optimize a local estimated total utility or a negotiated total utility in planning. The local estimated total utility means the vehicle gives weight to other vehicles in their ego-utility, whereas the negotiated total utility means the vehicle negotiates its behavior with other vehicles and optimizes the total utility. The last maneuver-based cooperation type is that every vehicle sends its sensor data, intention or desired trajectory to a centralized infrastructure, and the centralized infrastructure sends the desired trajectory to each vehicle by optimizing the total utility without any bias.

Therefore, the “global” 200 control of self-driving vehicles includes sub-sections 202 and sub-sub-sections 204 (and so on) where e.g., a self-driving vehicle 100 entering a freeway or the like can be controlled on the sub-sub-section (lowest section) level. In each sub-sub-section 204, the controller 218 having a database stored in the storage device 222 which includes data representing all features and variables relating to the self-driving vehicle 100 (i.e., the controller 218 knows everything about all the self-driving vehicles in its sub-sub-section). However, in the sub-section 202 above it (which controls several sub-sub- . . . sections), its controller 212 only knows what is needed to do a higher level of planning and feed the information to the sub-sub-sections 204 as they are needed. For example, such information can be that a self-driving vehicle 100a is about to leave one sub-sub-section 204 and enter into an adjacent sub-sub-section 204. This way, all the information stored in the database 222 is available to all the self-driving vehicles at all times with minimal resources that a global controller needs to have. With regard to self-driving vehicle 100a, sub-section controller 212 informs the sub-sub-section controller 218 in which self-driving vehicle 100a was previously in that self-driving vehicle 100a is leaving and informs the sub-sub-section controller 218 in the adjacent sub-sub-section 204 that the self-driving vehicle 100a is entering (along with all of the vehicle information corresponding to self-driving vehicle 100a).

Thus, the global network 200 includes sub-sections 202 (such as states), and each sub-section 202 is broken into sub-sub-sections 204 (such as cities and towns in each state) and the sub-sub-sections can be broken down into sub-sub-sub-sections (such as boroughs, counties or townships within each city or town) and so on.

This global system 200 is like a tree with branches. The section 200, sub-sections 202, sub-sub-sections 204, etc, can be different states, cities towns etc or simply different geometrical areas on a map (for example, a square having an area of 50 square miles). A section controller will have all the detailed information (location, direction, speed, destination, path of travel, condition, etc.) about all of the self-driving vehicles in its section (e.g., sub-sub-section) and this section controller will control the movement of all of the self-driving vehicles in its section. When a self-driving vehicle goes into another section (e.g., sub-sub-section), the information for that self-driving vehicle is passed to a section controller of that section (e.g., sub-sub-section).

The section controller that controls several (or all) sub-sections (and its sub-sections), only needs to know about vehicles that are going to cross their boundaries—and plan their interaction and pass the vehicle information to the adjacent sub-sub-section to be ready to take over its control.

In control systems, this is call hierarchical control, the operation thereof being well known in the art.

An advantage of this approach is that the highest (say the U.S. wide section) needs only limited information and does not need to have very fast communication links to control each individual vehicle (even if the system is down, the local sections, sub-sections, . . . can still do their job. And since the smallest sub-sub . . . section has ALL the information and details about everything (even link to all street cameras, other vehicle cameras, sensors, details location of everything, . . . , it can very quickly make correct decisions as to how to get each vehicle moving. The higher sub-section (controlling several sub-sub—sections), only need to know if any vehicle is going to cross into it or between sub-sections thereof and where it is going to go and what are all its information).

Self-driving vehicles are said to be those that “are capable of sensing their environment” and then safely move . . . However, the sensory information is at least in part provided via a network of other vehicles and the fixed or mobile “sensory,” “beacon” and “beacon with stored data” units in addition from its own sensors. “Beacon” as used herein is intended to mean “warning” or other “static” signs or “dynamic” signs that are centrally updated, and provide any type of data related to road conditions and hazards, etc.

The “vehicle collective” does not have to have each individual vehicle with very sophisticated and expensive and “far-looking” and “far-detecting” and . . . sensory system and therefore can become significantly cheaper than stand-alone versions

The system knows that a vehicle or pedestrian is approaching at an intersection or blind spot and also how fast and what it is, etc., therefore can easily plan to deal with it safely. If a vehicle is approaching an intersection and another car is also approaching from the crossing road, or if a car is entering a highway or exiting a highway into another road, they both can decide on how best to get by without having to slow down much or brake.

With regard to AI, the “organism” (the collective global system) as it grows, should be able to tell what new capabilities it can use and what would be gained by its addition and its “return-on-investment” in terms of life and property damage, etc. This could apply to additional “beacons” on the road or fixed cameras or other sensors on the vehicles or on the road, etc.

Further with regard to AI, the “organism” may not only learn from its experience, but it can also keep performing simulations, particularly of hazardous events such as earthquake, floods, fire conditions, etc. And be prepared to instantly take appropriate actions to minimize danger to humans and property and “instantaneously” inform others, whether in vehicles or outside through emergency announcements on radio and TV and mobiles, etc.

Users can pre-plan their trip and emulate on the map—with the ICSDVS using information and predictions of the road and traffic conditions to optimally plan the trip, suggest rest stops, etc.

The network can receive input from different sensors that may sense different hazardous conditions that may be encountered by a vehicle in the network and control the self-driving vehicles in its section to response to such conditions.

Each networked self-driving vehicle would also serve as local and movement planning and network node capable of making local decisions in general and can be provided with overall capability for nearby vehicles to collectively take on the role of the IC SDVS in case of network failure or slow response, etc.

The above sub-networks and local networks with the capability of providing the function of the ICSDVS via “locally networked self-driving vehicles”, provide multiple layers of redundancy, thereby giving the ICSDVS a remarkable level of reliability.

If only one self-driving vehicle is left alone “in the middle of a desert” with the overall network and all other networks down, then the self-driving vehicle will park the car and call the IC SDVS 911 or other places for help. This also applies if something goes wrong with the car itself (e.g., a breakdown).

The collected sensory information (e.g., those collected by camera, radar, Ladar, etc.) are converted into a “standard” format or code, etc., so that it can be stored and understood by other vehicles (e.g., classified as one of many objects (in code) and then provided with a list of parameters—including redundant ones if possible).

In order to solve the cooperative control problem, always one or a limited number of controllers that is in charge of a group of self-driving vehicles (VG) close to each other. The number of self-driving vehicles in the group can then change and be varied depending on vehicle density, etc., dynamically. There will then be a higher “supervisor” controller that feeds the VGs with a dynamic environmental data, which includes converging vehicles, etc. so that they are always aware of the “adjacent” groups.

The ICSDVS can store data about the behavior of different vehicles and their state of repair and upgrade and software update, etc., for proper service and maintenance scheduling.

The system can treat obstacles as either static obstacles or dynamic obstacles (like pedestrians and other non-integrated vehicles and even integrated vehicles that have lost connectivity or is out of control due to damage).

The planning is done in each vehicle and not by a group of vehicles (VG) in a certain region, that grows like a tree and that connects VGs and so on.

Data about the road (e.g., conditions or geometrical data, etc.) and other guiding information may be provided by the road signs, locally transmitted information, and the like.

Such methods have at least the following advantages: (1) reduce/eliminate human-error based accidents; (2) reduce time of travel and congestion, (3) prevent accidents due to vehicle breakdown—like tire blow up, etc. (4) reduce transportation cost by reducing fuel/electrical energy used; (5) increasing effectiveness of emergency workers by preplanned route generation and controls; (6) reduce wear and tear on the vehicles; (7) reduce repair and maintenance cost for the vehicles; (8) reduce car insurance costs to the owners and to the insurance company; (9) reduce injury related costs to vehicle users and to the insurance company; (10) reduce fatigue of vehicle users and increase their productivity at work and quality of life; (11) collect a data base that can help vehicle and system designers to improve the performance and predict the effect of each modification and its cost effectiveness based on all material and human costs and help city planners.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for controlling a group of self-driving vehicles in a predetermined geographical area, the method comprising:
separating the predetermined geographical area into at least first and second sub-sections, wherein the predetermined geographical area has a corresponding area controller and each of the at least first and second sub-sections has a corresponding sub-section controller;
separately controlling a sub-group of the self-driving vehicles within each of the at least first and second sub-sections using the corresponding sub-section controller; and
the area controller informing each corresponding sub-section controller of a change in a self-driving vehicle in the at least first or second sub-sections.

2. The method of claim 1, further comprising transmitting vehicle information from each self-driving vehicle in each of the at least first and second sub-sections to each corresponding sub-section controller.

3. The method of claim 2, further comprising, prior to the transmitting, storing the vehicle information in each self-driving vehicle in each of the at least first and second sub-sections.

4. The method of claim 1, wherein, the informing comprises informing the first sub-section when an other self-driving vehicle, that is not part of the sub-group of the self-driving vehicles corresponding to the first sub-section, enters the first sub-section.

5. The method of claim 4, further comprising controlling the other self-driving vehicle along with the corresponding group of self-driving vehicles in the first sub-section.

6. The method of claim 1, further comprising, the corresponding sub-section controller receiving sensory information from one or more of the self-driving vehicles in the corresponding sub-group of self-driving vehicles in the first sub-section and controlling the corresponding sub-group of self-driving vehicles in the first sub-section based on the received information.

7. The method of claim 1, further comprising, each of the self-driving vehicles of the first sub-group of self-driving vehicles in the first sub-section receiving sensory information from one or more of the self-driving vehicles in the corresponding sub-group of self-driving vehicles in the first sub-section and controlling the sub-group of self-driving vehicles in the first sub-section based on the received information.

8. The method of claim 1, further comprising, the corresponding sub-section controller receiving broadcast information and controlling the corresponding sub-group of self-driving vehicles in the first sub-section based on the received information.

9. The method of claim 1, wherein in a sub-section controller malfunction, a vehicle controller on-board one or more of the corresponding sub-group of self-driving vehicles acts as the sub-section controller.
